(19) United States
(12) Patent Application Publication
(10) Pub. No.: US 2006/0232595 A1
(43) Pub. Date: Oct. 19, 2006

(54) Rasterizer driven cache coherency

(76) Inventor: Stephen Junkins, Bend, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/108,989

(22) Filed: Apr. 18, 2005

(51) Int. Cl. G09G 5/36

(52) U.S. Cl. 345/557

(57) ABSTRACT

Apparatus, systems and methods for providing rasterizer driven cache coherency are disclosed. In one implementation, a system includes at least one rasterizer capable at least of identifying a rendering order conflict between first and second portions of pixel data and of generating one or more indicators of the rendering order conflict, at least one memory responsive to the one or more indicators and at least capable of retaining memory contents associated with the first portion of pixel data in response to the one or more indicators, and a display processor responsive to the rasterizer and at least capable of displaying image data resulting, at least in part, from rasterization of the first and second portions of pixel data.

### BACKGROUND

3D graphics rendering has been implemented extensively in a variety of hardware (HW) architectures over the past few decades. With the advent of standardized rendering application programming interfaces (APIs) such as OpenGL and more recently DirectX/Direct3D, a similar macro architectural structure has begun to emerge. The details and performance of any particular graphics HW architecture often hinges upon the number of pixel processing pipelines that may be dedicated to this HW architecture, how many stages the various pipelines require, as well as the effectiveness of a variety of cache memories strategically designed throughout the architecture. For instance, some modern graphics architectures include eight or more pixels processing units to handle pixel shading along with two or more cache memories associated with those processing units.

Dependencies between multiple graphics processing pipelines often restrict the overall processing speed of the graphics HW architecture. But such dependencies may also provide opportunities for enhancing processing speed by enabling the recognition of wasteful activities such as the eviction of cache memory contents utilized by one processing pipeline that, as it turns out, will be used by another processing pipeline.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example graphics processing system;

FIG. 2 illustrates a portion of the graphics processor of the system of FIG. 1 in more detail;

FIGS. 3A and 3B illustrate implementations of a portion of the graphics processor of FIG. 1 in more detail; and

FIG. 4 is a flow chart illustrating an example process of providing graphics cache coherency.

### DETAILED DESCRIPTION

The following detailed description refers to the accompanying drawings. The same reference numbers may be used in different drawings to identify the same or similar elements. In the following description specific details are set forth such as particular structures, architectures, interfaces, techniques, etc. in order to provide a thorough understanding of the various aspects of the claimed invention. However, such details are provided for purposes of explanation and should not be viewed as limiting. Moreover, it will be apparent to those skilled in the art, having the benefit of the present disclosure, that the various aspects of the invention claimed may be practiced in other examples that depart from these specific details. In certain instances, descriptions of well known devices, circuits, and methods are omitted so as not to obscure the description of the present invention with unnecessary detail.

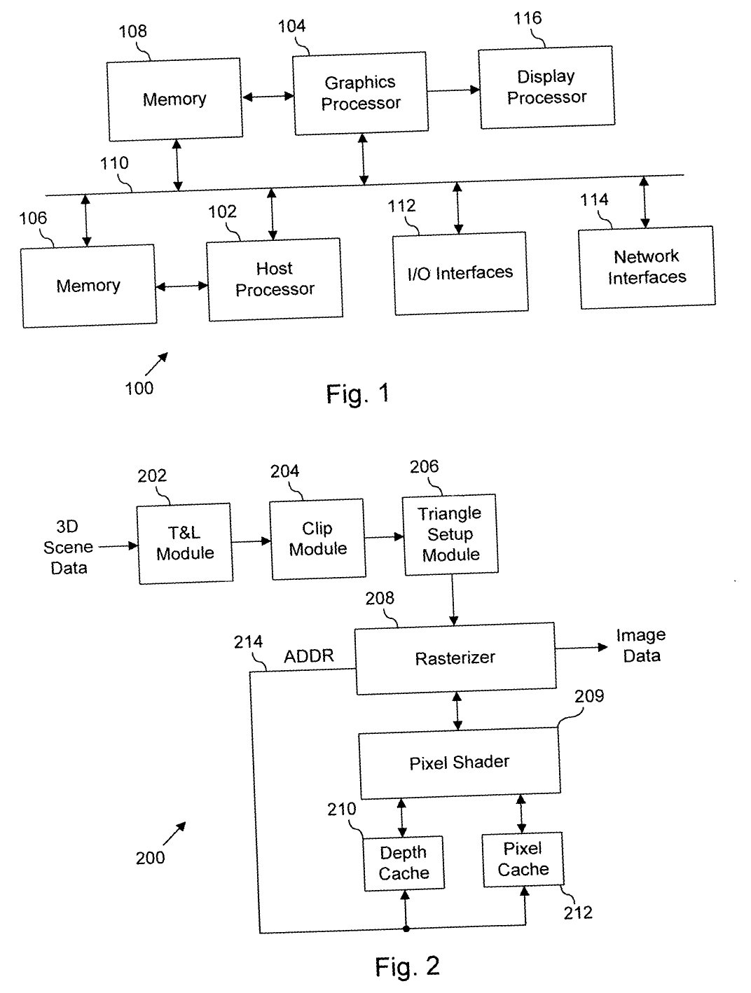

FIG. 1 illustrates an example system 100 according to an implementation of the invention. System 100 may include a host processor 102, a graphics processor 104, memories 106 and 108 (e.g., dynamic random access memory (DRAM), static random access memory (SRAM), flash, etc.), a bus or communications pathway(s) 110, input/output (I/O) interfaces 112 (e.g., universal synchronous bus (USB) interfaces, parallel ports, serial ports, telephone ports, and/or other I/O interfaces), network interfaces 114 (e.g., wired and/or wireless local area network (LAN) and/or wide area network (WAN) and/or personal area network (PAN), and/or other wired and/or wireless network interfaces), and a display processor and/or controller 116. System 100 may be any system suitable for processing 3D graphics data and providing that data in a rasterized format suitable for presentation on a display device (not shown) such as a liquid crystal display (LCD), or a cathode ray tube (CRT) display to name a few examples.

System 100 may assume a variety of physical implementations. For example, system 100 may be implemented in a personal computer (PC), a networked PC, a server computing system, a handheld computing platform (e.g., a personal digital assistant (PDA)), a gaming system (portable or otherwise), a 3D capable cell phone, etc. Moreover, while all components of system 100 may be implemented within a single device, such as a system-on-a-chip (SOC) integrated circuit (IC), components of system 100 may also be distributed across multiple ICs or devices. For example, host processor 102 along with components 106, 112, and 114 may be implemented as multiple ICs contained within a single PC while graphics processor 104 and components 108 and 116 may be implemented in a separate device such as a television coupled to host processor 102 and components 106, 112, and 114 through communications pathway 110.

Host processor 102 may comprise a special purpose or a general purpose processor including any processing logic, hardware, software and/or firmware, capable of providing graphics processor 104 with 3D graphics data and/or instructions. Processor 102 may perform a variety of 3D graphics calculations such as 3D coordinate transformations, etc. the results of which may be provided to graphics processor 104 over bus 110 and/or that may be stored in memories 106 and/or 108 for eventual use by processor 104.

In one implementation, host processor 102 may be capable of performing any of a number of tasks that support 3D graphics processing. These tasks may include, for example, although the invention is not limited in this regard, providing 3D scene data to graphics processor 104, downloading microcode to processor 104, initializing and/or configuring registers within processor 104, interrupt servicing, and providing a bus interface for uploading and/or downloading 3D graphics data. In alternate implementations, some or all of these functions may be performed by processor 104. While system 100 shows host processor 102 and graphics processor 104 as distinct-components, the invention is not limited in this regard and those of skill in the art will recognize that processors 102 and 104 possibly in addition to other components of system 100 may be implemented within a single IC where processors 102 and 104 may be distinguished by the respective types of 3D graphics processing that they implement.

Graphics processor 104 may comprise any processing logic, hardware, software, and/or firmware, capable of processing graphics data. In one implementation, graphics processor 104 may implement a 3D graphics hardware architecture capable of processing graphics data in accordance with one or more standardized rendering application programming interfaces (APIs) such as OpenGL and more recently DirectX/Direct3D to name a few examples, although the invention is not limited in this regard. Graphics processor 104 may process 3D graphics data provided by host processor 102, held or stored in memories 106 and/or 108, and/or provided by sources external to system 100 and obtained over bus 110 from interfaces 112 and/or 114. Graphics processor 104 may receive 3D graphics data in the form of 3D scene data and process that data to provide image data in a format suitable for conversion by display processor 116 into display-specific data. In addition, graphics processor 104 may include a variety of 3D graphics processing components such as one or more rasterizers coupled to one or more pixel shaders as will be described in greater detail below.

Bus or communications pathway(s) 110 may comprise any mechanism for conveying information (e.g., graphics data, instructions, etc.) between or amongst any of the elements of system 100. For example, although the invention is not limited in this regard, communications pathway(s) 110 may comprise a multipurpose bus capable of conveying, for example, instructions (e.g., macrocode) between processor 102 and processor 104. Alternatively, pathway(s) 110 may comprise a wireless communications pathway.

Display processor 116 may comprise any processing logic, hardware, software, and/or firmware, capable of converting image data supplied by graphics processor 104 into a format suitable for driving a display (i.e., display-specific data). For example, while the invention is not limited in this regard, processor 104 may provide image data to processor 116 in a specific color data format, for example in a compressed red-green-blue (RGB) format, and processor 116 may process such RGB data by generating, for example, corresponding LCD drive data levels etc. Although FIG. 1 shows processors 104 and 116 as distinct components, the invention is not limited in this regard, and those of skill in the art will recognize that some if not all of the functions of display processor 116 may be performed by processor 104.

FIG. 2 is a simplified block diagram of a portion of a graphics processor 200 (e.g., graphics processor 104, FIG. 1), in accordance with an implementation of the claimed invention. Processor 200 may include a transform and lighting (T&L) module 202, a clip module 204, a triangle setup module 206, one or more rasterizers 208, one or more pixel shaders 209, a depth cache 210, a pixel cache 212, and one or more address (ADDR) and/or control line(s) 214.

Those skilled in the art will recognize that some components typically found in graphics processors (e.g., tessellation modules, etc.) and not particularly germane to the claimed invention have been excluded from FIG. 2 so as not to obscure implementations of the invention. Moreover, while FIG. 2 illustrates rasterizer 208 and pixel shader 209, those skilled in the art will recognize that more than one rasterizer 208 and/or more than one pixel shader 209 may be implemented without departing from the scope and spirit of the claimed invention. Several components of processor 200, namely T&L module 202, clip module 204, and triangle setup module 206, while included in FIG. 2 in the interest of completeness, may be considered to operate in a manner conventional to graphics processors and will not be discussed in greater detail herein.

Rasterizer 208 may be capable of processing pixel fragments provided by triangle setup module 206 to generate image data suitable for processing by display processor 116 (FIG. 1). Rasterizer 208 may comprise any graphics processing logic and/or hardware, software, and/or firmware, capable of controlling, at least partly, the operation of pixel shader 209 and/or caches 210 and 212 in accordance with implementations of the invention as described herein. In particular, in one implementation of the invention, rasterizer 208 may operatively control caches 210 and/or 212 using control line(s) 214 in a manner to be described in greater detail below.

Rasterizer 208 and/or shader 209 may process pixel fragments in discrete portions and/or “spans” of pixel data (e.g., pixel fragments) provided by triangle setup module 206 and should, as those skilled in the art will recognize, process such spans in the order that they are received from module 206 (i.e., processed in “rendering order”). Moreover, as will be described in greater detail below, Rasterizer 208 and/or shader 209 may process two or more spans more or less concurrently. Pixel shader 209 may comprise any graphics processing logic and/or hardware, software, and/or firmware, capable of using pixel depth and/or pixel color data supplied respectively by cache 210 and/or cache 212 to render and/or process pixel spans.

Those skilled in the art will recognize that, while some spans may take longer to process than other spans, two or more spans that correspond to spatially overlapping portions of a frame buffer (not shown) should be processed in the order received by rasterizer 208 and/or shader 209 to ensure compliance with conventional rendering order constraints (e.g., when alpha blending is enabled). Hence, in accordance with one implementation of the invention, rasterizer 208 may identify and/or recognize one or more rendering order conflicts between two or more spans it is processing and may use that information to control caches 210 and/or 212 so that one or more lines of cache content are retained for use by shader 209 in rendering and/or processing those spans. In other words, as will be described in more detail below, rasterizer 208 may provide one or more indicators caches 210 and/or 212 that may cause the caches to retain at least some of their contents at least temporarily.

Cache 210 may comprise any memory or collection of memories capable of at least storing pixel depth information to be used by rasterizer 208 and/or shader 209. Pixel cache 212 may comprise any memory or collection of memories capable of at least storing pixel color information to be used by rasterizer 208 and/or shader 209. In accordance with an implementation of the invention, caches 210 and/or 212 may respond to one or more indicators and/or control data (e.g., cache line address data) provided by rasterizer 208 over line(s) 214 by holding and/or retaining one or more lines of cache data as will be described in greater detail below. While FIG. 2 shows control line(s) 214 as discrete ADDR line(s), the invention is not limited in this regard and those skilled in the art will recognize that other structures and/or methods may be utilized in accordance with the invention to permit rasterizer 208 to specify and/or control and/or indicate that one or more lines of memory content in caches 210 and/or 212 should be held and/or locked and/or retained in accordance with implementations of the invention.

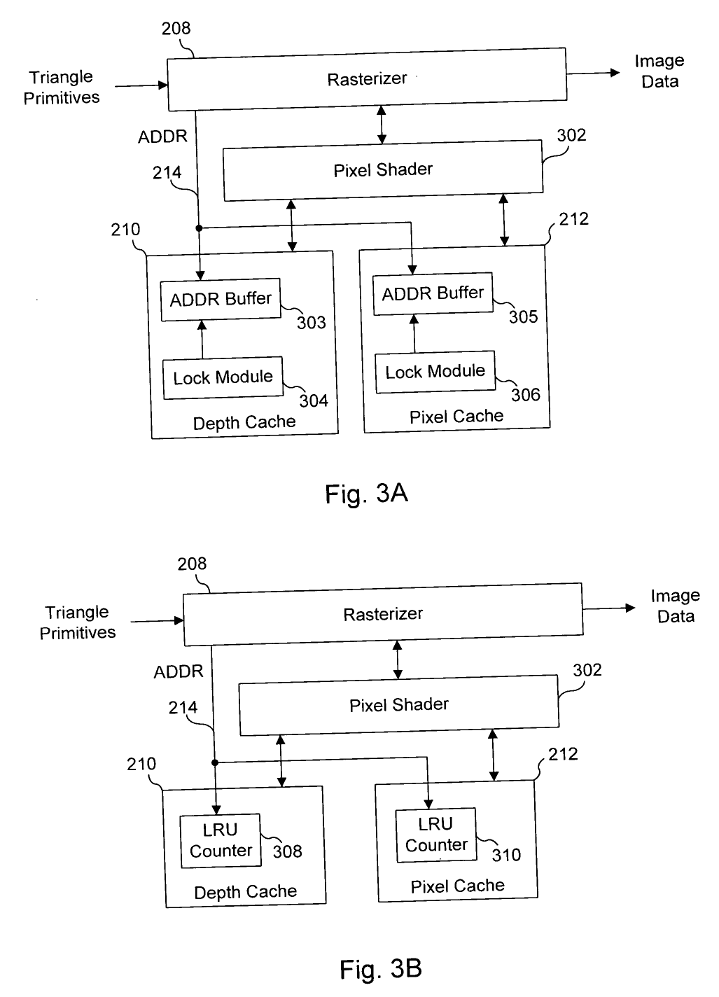

FIGS. 3A and 3B are simplified block diagrams of portions of graphics processor 200, in accordance with two respective implementations of the invention. In addition to those elements discussed with reference to FIG. 2, the implementation of FIG. 3A also includes first and second address buffers 303 and 305 associated, respectively, with caches 210 and 212 and coupled to rasterizer 208 by control line(s) 214. Also associated with caches 210 and 212 are first and second lock modules 304 and 306 coupled, respectively, to buffers 303 and 305. In addition to those elements discussed with reference to FIG. 2, the implementation of FIG. 3B also includes first and second least-recently-used (LRU) counters 308 and 310 coupled, respectively, to caches 210 and 212 and to rasterizer 208 by control line(s) 214.

Referring to FIG. 3A, rasterizer 208 may indicate, via control line(s) 214 coupled to buffers 303 and 305, that respective caches 210 and/or 212 should retain certain portions of their content. In one implementation, in response to one or more cache line addresses supplied by rasterizer 208 to buffers 303 and 305, respective lock modules 304 and 306 may, at least temporarily, lock and/or hold the content of those cache line addresses. For example, although the invention is not limited in this regard, rasterizer 208 may identify that a rendering conflict exists between two or more spans (e.g., because alpha blending is enabled for those spans) and may supply buffers 303 and/or 305, via line(s) 214, with one or more cache line addresses (e.g., conflicted cache line addresses) corresponding to content associated with a first span being processed. In response to the conflicted cache line addresses supplied by rasterizer 208, lock modules 304 and/or 306 may lock those conflicted cache line addresses if the content associated with that first span is present in those cache line addresses in either of caches 210 and/or 212.

Referring to FIG. 3B, rasterizer 208 may indicate, via control line(s) 214 coupled to respective LRU counters 308 and 310, that one and/or both of caches 210 and/or 212 should retain certain portions of their content by setting or resetting respective LRU counters 308 and/or 310 associated with that content. For example, although the invention is not limited in this regard, rasterizer 208 may recognize that a rendering conflict exists between two or more spans and, in response, may indicate that for specific conflicted cache line addresses of cache 210 and/or cache 212 associated LRU counter values should be set or reset thus designating the associated cache memory content as most recently used.

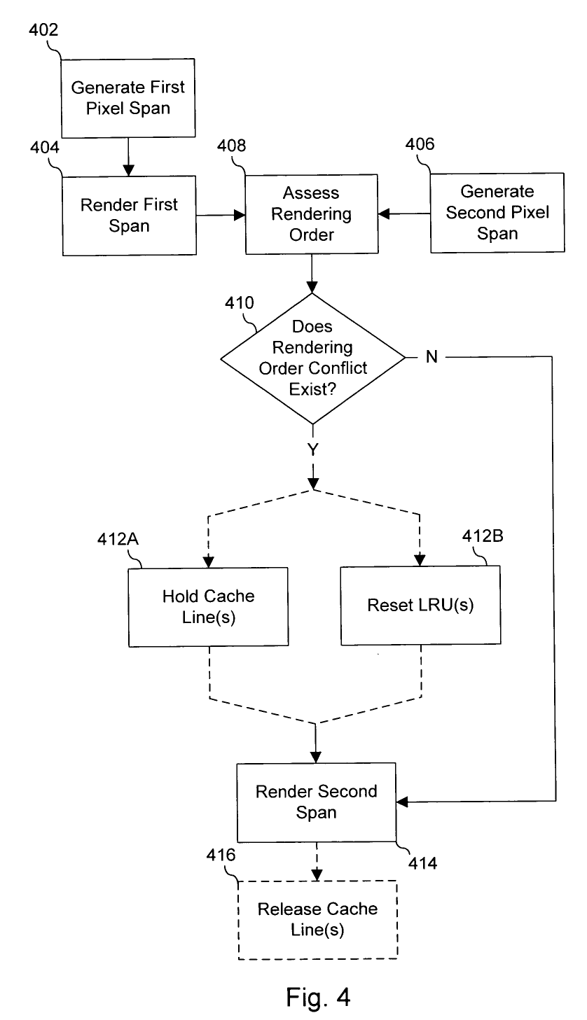

FIG. 4 is a flow chart illustrating a process 400 for providing rasterizer driven cache coherency in accordance with an implementation of the invention. While, for ease of explanation, process 400, and associated processes, may be described with regard to system 100 of FIG. 1 and processor 200 of FIGS. 2, 3A, and 3B, the claimed invention is not limited in this regard and other processes or schemes supported by appropriate devices in accordance with the claimed invention are possible.

Process 400 may begin with the generation of a first pixel span [act 402]. In one implementation, rasterizer 208 may generate the first pixel span according to conventional procedures. For example, rasterizer 208 may generate the first pixel span using a conventional process of “scan” converting triangle based primitives (specified in “vertice” or “object” space) into spans of discrete pixels (specified in “screen” or “display” space).

Process 400 may continue with the shading and/or rendering of the first span [act 404]. In one implementation, shader 209 may process the first span using one or more of a number of conventional pixel shading techniques, although the invention is not limited in this regard. For example, shader 209 may compare the depth data of the first span as stored in and supplied by depth cache 210 to a depth value stored in a “z buffer” (not shown). In addition, shader 209 may render pixel colors for the span using color information stored in and supplied by pixel cache 212.

Process 400 may continue with the generation of a second pixel fragment span [act 406]. In one implementation, rasterizer 208 may generate the second pixel span in the manner as described above for the first pixel span in act 402. Process 400 may then continue with an assessment of the rendering order of the first and second pixel spans [act 408]. In one implementation, rasterizer 208 may compare the spatial attributes of the first span to those of the second span. In other words, rasterizer 208 may compare the two spans to see whether they correspond or “map” to the same region of screen space (i.e., frame buffer space).

Process 400 may continue with a determination of whether a rendering order conflict exists [act 410]. In one implementation, rasterizer 208 may use the results of act 408 to determine if a rendering order conflict may exist. For example, in one implementation, if the first and second spans map to the same screen space and alpha blending is enabled then a rendering conflict exists and process 400 proceeds to act 412A or to act 412B. Otherwise, if the first and second spans do not map to the same screen space and/or alpha blending is not enabled then a rendering conflict does not exist and process 400 proceeds to act 414.

If a rendering order conflict exists then, in one implementation, one or more cache lines associated with the first span may be held and/or retained and/or locked [act 412A] for use in processing the second span. In one implementation, referring also to FIG. 3A, rasterizer 208 may provide indicators and/or control data in the form of one or more conflicted cache line addresses via line(s) 214 to buffers 303 and/or 305. In response to those indicators supplied to buffers 303 and/or 305, respective lock modules 304 and 306 of caches 210 and/or 212 may retain, hold and/or lock the contents of those cache lines (i.e., to, at least temporarily, not subject the content of those cache lines to routine cache retention schemes).

Alternatively, referring to the implementation of FIG. 3B, if a rendering order conflict exists then LRU counters associated with one or more cache line addresses may be set or reset [act 412B]. One way this may be done is to have rasterizer 208 provide one or more indicators and/or control data (e.g., one or more conflicted cache line addresses) over line(s) 214. In response, caches 210 and/or 212 may set or reset their respective LRU counters 308 and/or 310 to indicate that memory content associated with the one or more indicators is most recently used. By setting or resetting respective counters 308 and/or 310, caches 210 and/or 212 may retain content associated with the one or more indicators provided by rasterizer 208.

Process 400 may continue with the rendering of the second pixel span [act 414]. In one implementation, shader 208 may render the second pixel span in the manner as described above for the first pixel span in act 404. In accordance with implementations of the invention, shader 208 may render the second pixel span using, at least in part, those contents of caches 210 and/or 212 used to render the first span in act 404 and subsequently retained in either act 412A or act 412B.

Process 400 may conclude with the release [act 416] of any cache lines held and/or retained and/or locked in act 412A. One way to do this is to have rasterizer 208 provide control data via line(s) 214 to buffers 303 and/or 305 directing respective lock modules 304 and/or 306 of caches 210 and/or 212 to unlock the contents of those cache lines (i.e., to subject the content of those cache lines to routine cache retention schemes). One way to do this is to have rasterizer 208 remove from buffers 303 and/or 305 those conflicted cache line addresses supplied in act 412A.

The acts shown in FIG. 4 need not be implemented in the order shown; nor do all of the acts necessarily need to be performed. For example, act 404, the rendering of the first span, need not be performed before assessing rendering order in act 408 but may be performed at any point prior to either of acts 412(A) or 412(B). Also, those acts that are not dependent on other acts may be performed in parallel with the other acts. Further, at least some of the acts in this figure may be implemented as instructions, or groups of instructions, implemented in a machine-readable medium.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. For example, while FIGS. 2 and 3A/3B and the accompanying text may show and describe a graphics processor including two graphics caches, one rasterizer, and one pixel shader, those skilled in the art will recognize that graphics processors in accordance with the invention may include more or less than two graphics caches and/or more than one rasterizer and/or pixel shader. Clearly, many other implementations may be employed to provide rasterizer driven cache coherency consistent with the claimed invention.

No element, act, or instruction used in the description of the present application should be construed as critical or essential to the invention unless explicitly described as such. Also, as used herein, the article “a” is intended to include one or more items. Moreover, when terms such as “coupled” or “responsive” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
identifying a rendering order conflict between at least a first pixel span and a second pixel span; and
retaining, in response to the identification of the rendering order conflict, one or more portions of memory content associated with the first pixel span.

2. The method of claim 1, further comprising:
rendering the second pixel span using the one or more portions of memory content.

3. The method of claim 1, wherein the one or more portions of memory content comprise one or more lines of cache memory content.

4. The method of claim 3, wherein retaining comprises locking the one or more lines of cache memory content.

5. The method of claim 4, further comprising:
rendering the second pixel span using the one or more lines of cache memory content; and
unlocking the one or more lines of cache memory content.

6. The method of claim 4, wherein retaining comprises locking the one or more lines of cache memory content in response to addresses of the one or more lines of cache memory content supplied to one or more buffers.

7. The method of claim 4, wherein retaining comprises setting or resetting one or more least-recently-used (LRU) indicators associated with the one or more lines of cache memory content.

8. A system comprising:
at least one rasterizer capable at least of identifying a rendering order conflict between first and second portions of pixel data and of generating one or more indicators of the rendering order conflict;
at least one memory responsive to the one or more indicators, the memory at least capable of retaining memory contents associated with the first portion of pixel data in response to the one or more indicators; and
a display processor responsive to the rasterizer, the display processor at least capable of displaying image data resulting, at least in part, from rasterization of the first and second portions of pixel data.

9. The system of claim 8, further comprising at least one shader capable of at least rendering the second portion of pixel data using the retained memory contents.

10. The system of claim 8, wherein the first and second portions of pixel data comprise first and second pixel spans.

11. The system of claim 10, wherein the memory contents comprise depth and/or color data associated with one or more pixel fragments of the first pixel span.

12. The system of claim 8, further comprising one or more address buffers coupled to the at least one memory.

13. The system of claim 12, wherein the one or more indicators comprise one or more memory addresses held in the one or more address buffers.

14. The system of claim 13, wherein the at least one memory comprises at least one cache memory; and
wherein the one or more memory addresses comprise one or more conflicted cache line addresses provided by the at least one rasterizer.

15. The system of claim 13, wherein the cache memory is at least capable of retaining memory contents associated with the one or more conflicted cache line addresses by locking the cache lines indicated by the one or more conflicted cache line addresses.

16. The system of claim 8, wherein the at least one memory comprises at least one cache memory; and
wherein the one or indicators comprise one or more conflicted cache line addresses generated by the at least one rasterizer.

17. The system of claim 16, wherein the cache memory is at least capable of retaining memory contents associated with the one or more conflicted cache line addresses by setting or resetting one or more least recently used counters.

18. A device comprising:
at least one rasterizer capable of at least generating control data indicating a rendering order conflict between first and second pixel spans to be rasterized; and
cache memory at least capable of retaining memory content associated with the first pixel span in response to the control data.

19. The device of claim 18, further comprising:
at least one buffer coupled to the cache memory, the buffer at least capable of holding the control data.

20. The device of claim 18, wherein the control data comprises at least one cache memory address.

21. The device of claim 20, wherein the at least one cache memory address comprises at least one conflicted cache memory address provided by the rasterizer.

22. The device of claim 21, further comprising:
a locking module coupled to the at least one buffer; and
wherein, in response to the at least one conflicted cache memory address, the locking module is capable of locking cache memory content associated with the at least one conflicted cache memory address.

23. The device of claim 20, further comprising:
at least one least recently used counter coupled to the cache memory, the least recently used counter at least capable of being set or reset in response to the at least one cache memory address.

24. An article comprising a machine-accessible medium having stored thereon instructions that, when executed by a machine, cause the machine to:
identify a rendering order conflict between at least a first pixel span and a second pixel span; and
retain, in response to the identification of the rendering order conflict, one or more portions of memory content associated with the first pixel span.

25. The article of claim 24, wherein the instructions, when executed by a machine, further cause the machine to:
render the second pixel span using the one or more portions of memory content.

26. The article of claim 24, wherein the one or more portions of memory content comprise one or more lines of cache memory content

27. The article of claim 26, wherein the instructions to retain, when executed by a machine, cause the machine to:
lock the one or more lines of cache memory content.

28. The article of claim 27, wherein the instructions, when executed by a machine, further cause the machine to:
render the second pixel span using the one or more lines of cache memory content; and
unlock the one or more lines of cache memory content.

29. The article of claim 26, wherein the instructions to retain, when executed by a machine, cause the machine to:
set or reset one or more least-recently-used (LRU) indicators coupled with the one or more lines of cache memory content.
